(19) United States
(12) Patent Application Publication
(10) Pub. No.: US 2025/0327715 A1
(43) Pub. Date: Oct. 23, 2025

(54) APPARATUS, SYSTEM, AND METHOD FOR DETECTING AN ABNORMALITY IN A STRUCTURE

(71) Applicant: The Boeing Company, Arlington, VA (US)

(72) Inventors: Jeong-Beom Ihn, Bellevue, WA (US); James Dunne, Baldwin, MO (US); Lawrence Pado, St. Charles, MO (US); Sabyasachi Basu, Kingston, WA (US); Walter Jarecki, Chino Hills, CA (US); John Tidwell, Huntington Beach, CA (US); William Grace, Vashon, WA (US); Ben K. Lee, Seattle, WA (US); Mohamed Azdamou, Seattle, WA (US); Nihar Desai, Bothell, WA (US); Ohchang Jin, Bellevue, WA (US)

(21) Appl. No.: 18/638,510

(22) Filed: Apr. 17, 2024

(51) Int. Cl. G01M 7/02

(52) U.S. Cl. CPC G01M 7/025

(57) ABSTRACT

An apparatus for detecting an abnormality in a structure includes a base, configured to be attached to the structure, and piezoelectric transducers, configured to generate waves through the structure, coupled to the base, spaced apart from each other, and aligned with each other along a transducer plane. The apparatus additionally includes piezoelectric sensors configured to sense the waves generated by the piezoelectric transducers, coupled to the base, spaced apart from each other, and aligned with each other along a lateral sensor plane. A distance between adjacent ones of the piezoelectric sensors is the same. A size of each one of the piezoelectric transducers is greater than a size of each one of the piezoelectric sensors. A distance between the transducer plane and the lateral sensor plane is greater than a distance between adjacent ones of the piezoelectric transducers and greater than a distance between adjacent ones of the piezoelectric sensors.

### FIELD

This disclosure relates generally to detecting abnormalities in a structure, and more particularly to detecting abnormalities in a structural component of an aircraft using a piezoelectric sensor apparatus, system, and method.

### BACKGROUND

Structures experiencing loads or exposed to various environmental factors are susceptible to abnormalities in the structures, such as cracking, corrosion, delamination, and the like. Abnormalities in structures may lead to aesthetic flaws, structural degradation, inefficiencies, and poor performance. Accordingly, the detection of abnormalities in structures may be desirable to mitigate or prevent the occurrence of such consequences. In some circumstances, the consequences of abnormalities in the structure can be mitigated or prevented through detection and repair of the damage.

Some structures include features that are particularly susceptible to abnormalities or the inducement of abnormalities. For example, cracks are more likely to form at and emanate from fastener holes in surfaces of certain structures, such as aircraft. Prompt, efficient, and accurate detection of such abnormalities, particularly with complex structures like aircraft, can be difficult.

### SUMMARY

The subject matter of the present application has been developed in response to the present state of the art, and in particular, in response to the problem of, and the need to, detect abnormalities, such as crack formations, in various structures, such as aircraft, that have not yet been fully solved by currently available techniques. Once a structure is disassembled, partially disassembled, or accessed, conventional detection methods, such as non-destructive ultrasonic testing techniques, may be used to detect such abnormalities. However, the time and effort associated with disassembly of, ultrasonic testing of, reassembly or, and/or accessing difficult to reach some structures using conventional techniques can be overly burdensome in both time and cost. Accordingly, the subject matter of the present application has been developed to provide an apparatus, system, and method for detecting damage in a structure that overcome at least some of the above-discussed shortcomings of prior art techniques.

The following is a non-exhaustive list of examples, which may or may not be claimed, of the subject matter, disclosed herein.

Disclosed herein is an apparatus for detecting an abnormality in a structure. The apparatus includes a base configured to be attached to the structure. The apparatus also includes piezoelectric transducers configured to generate waves through the structure, coupled to the base, spaced apart from each other, and aligned with each other along a transducer plane. The apparatus additionally includes piezoelectric sensors configured to sense the waves generated by the piezoelectric transducers, coupled to the base, spaced apart from each other, and aligned with each other along a lateral sensor plane. A distance between adjacent ones of the piezoelectric sensors is the same. The lateral sensor plane is parallel to the transducer plane. A size of each one of the piezoelectric transducers is greater than a size of each one of the piezoelectric sensors. A distance between the transducer plane and the lateral sensor plane is greater than a distance between adjacent ones of the piezoelectric transducers and greater than a distance between adjacent ones of the piezoelectric sensors. The preceding subject matter of this paragraph characterizes example 1 of the present disclosure.

A ratio of the size of each one of the piezoelectric transducers to the size of each one of the piezoelectric sensors is between, and inclusive of, 1.5 and 2.5. The preceding subject matter of this paragraph characterizes example 2 of the present disclosure, wherein example 2 also includes the subject matter according to example 1, above.

The ratio of the size of each one of the piezoelectric transducers to the size of each one of the piezoelectric sensors is between, and inclusive of, 1.8 and 2.2. The preceding subject matter of this paragraph characterizes example 3 of the present disclosure, wherein example 3 also includes the subject matter according to example 2, above.

A ratio of the distance between the transducer plane and the lateral sensor plane to either the distance between adjacent ones of the piezoelectric transducers or the distance between adjacent ones of the piezoelectric sensors is between, and inclusive of, 2.2 and 3.2. The preceding subject matter of this paragraph characterizes example 4 of the present disclosure, wherein example 4 also includes the subject matter according to any of examples 1-3, above.

The ratio of the distance between the transducer plane and the lateral sensor plane to either the distance between adjacent ones of the piezoelectric transducers or the distance between adjacent ones of the piezoelectric sensors is between, and inclusive of, 2.5 and 2.9. The preceding subject matter of this paragraph characterizes example 5 of the present disclosure, wherein example 5 also includes the subject matter according to example 4, above.

The distance between adjacent ones of the piezoelectric transducers is the same. The distance between adjacent ones of the piezoelectric sensors is the same. The preceding subject matter of this paragraph characterizes example 6 of the present disclosure, wherein example 6 also includes the subject matter according to any of examples 1-5, above.

Each one of the piezoelectric transducers and the piezoelectric sensors is disc-shaped. The preceding subject matter of this paragraph characterizes example 7 of the present disclosure, wherein example 7 also includes the subject matter according to any of examples 1-6, above.

The piezoelectric transducers are staggered, in a direction parallel to the transducer plane and the lateral sensor plane, relative to the piezoelectric sensors such that longitudinal sensor planes, each passing through a corresponding one of the piezoelectric sensors and each being perpendicular to the transducer plane and the lateral sensor plane, do not pass through any one of the piezoelectric transducers. The preceding subject matter of this paragraph characterizes example 8 of the present disclosure, wherein example 8 also includes the subject matter according to any of examples 1-7, above.

Each one of the longitudinal sensor planes passing between adjacent ones of the piezoelectric transducers bisects the distance between the adjacent ones of the piezoelectric transducers. The preceding subject matter of this paragraph characterizes example 9 of the present disclosure, wherein example 9 also includes the subject matter according to example 8, above.

The apparatus further includes second piezoelectric sensors coupled to the base, spaced-apart from each other, each having a size less than the size of each one of the piezoelectric transducers, and aligned with each other along a second lateral sensor plane. Adjacent ones of the second piezoelectric sensors are separated by a distance equal to the distance between adjacent ones of the piezoelectric sensors. The second lateral sensor plane is parallel to and spaced apart from the lateral sensor plane. Each one of the second piezoelectric sensors is aligned with a corresponding one of the piezoelectric sensors along a corresponding one of longitudinal sensor planes that are perpendicular to the transducer plane and the lateral sensor plane. The preceding subject matter of this paragraph characterizes example 10 of the present disclosure, wherein example 10 also includes the subject matter according to any of examples 1-9, above.

A distance between the lateral sensor plane and the second lateral sensor plane is greater than the distance between adjacent ones of the piezoelectric sensors and less than the distance between the transducer plane and the lateral sensor plane. The preceding subject matter of this paragraph characterizes example 11 of the present disclosure, wherein example 11 also includes the subject matter according to example 10, above.

The size of each one of the second piezoelectric sensors is the same as the size of each one of the piezoelectric sensors. The preceding subject matter of this paragraph characterizes example 12 of the present disclosure, wherein example 12 also includes the subject matter according to example 11, above.

The apparatus further includes a data communications module coupled to the base and electrically coupleable, in electrical-power providing communication, to each one of the piezoelectric transducers, and electrically coupleable, in electrical-power receiving communication, to each one of the piezoelectric sensors. The preceding subject matter of this paragraph characterizes example 13 of the present disclosure, wherein example 13 also includes the subject matter according to any of examples 1-12, above.

The apparatus further includes an electronic controller communicable in data providing and data receiving communication with the data communications module. The electronic controller includes a transducer module configured to generate a transducer command. The piezoelectric transducers generate waves through the structure in response to receiving the transducer command. The electronic controller also includes a structure condition module configured to determine whether an abnormality is present in the structure at least partially in response to sensor output from the piezoelectric sensors. The preceding subject matter of this paragraph characterizes example 14 of the present disclosure, wherein example 14 also includes the subject matter according to example 13, above.

The base includes a body and elongated fingers extending from the body and spaced apart relative to each other. The piezoelectric transducers are coupled directly to the body. Each one of the piezoelectric sensors is coupled directly to a corresponding one of the elongated fingers. The preceding subject matter of this paragraph characterizes example 15 of the present disclosure, wherein example 15 also includes the subject matter according to any of examples 1-14, above.

Each one of the piezoelectric transducers has line-of-sight with each one of the piezoelectric sensors. The preceding subject matter of this paragraph characterizes example 16 of the present disclosure, wherein example 16 also includes the subject matter according to any of examples 1-15, above.

Further disclosed herein is a system that includes a structure and an apparatus for detecting an abnormality in the structure. The apparatus is attached to the structure and includes a base. The apparatus also includes piezoelectric transducers configured to generate waves through the structure, coupled to the base, spaced apart from each other, and aligned with each other along a transducer plane. A distance between adjacent ones of the piezoelectric transducers is the same. The apparatus further includes piezoelectric sensors configured to sense the waves generated by the piezoelectric transducers, coupled to the base, spaced apart from each other, and aligned with each other along a lateral sensor plane. A distance between adjacent ones of the piezoelectric sensors is the same. The lateral sensor plane is parallel to the transducer plane. A size of each one of the piezoelectric transducers is greater than a size of each one of the piezoelectric sensors. A distance between the transducer plane and the lateral sensor plane is greater than the distance between adjacent ones of the piezoelectric transducers and greater than the distance between adjacent ones of the piezoelectric sensors. A ratio of the distance, between the transducer plane and the lateral sensor plane, to a thickness of the structure is between, and inclusive of, 75 and 85. The preceding subject matter of this paragraph characterizes example 17 of the present disclosure.

The ratio of the distance, between the transducer plane and the lateral sensor plane, to a thickness of the structure is between, and inclusive of, 78 and 80. The preceding subject matter of this paragraph characterizes example 18 of the present disclosure, wherein example 18 also includes the subject matter according to example 17, above.

The structure includes holes spaced apart from each other and aligned with each other along a hole plane that is parallel to the transducer plane and the lateral sensor plane. The base includes a body and elongated fingers extending from the body and spaced apart relative to each other. The piezoelectric transducers are coupled directly to the body. Each one of the piezoelectric sensors is coupled directly to a corresponding one of the elongated fingers. Each one of the holes is between corresponding adjacent ones of the elongated fingers. The preceding subject matter of this paragraph characterizes example 19 of the present disclosure, wherein example 19 also includes the subject matter according to any of examples 17-18, above.

Additionally disclosed herein is a method of detecting an abnormality in a structure. The method includes generating acoustic waves through the structure from piezoelectric transducers coupled with the structure, spaced apart from each other, and aligned with each other along a transducer plane. The method also includes sensing the acoustic waves at piezoelectric sensors coupled with the structure, spaced apart from each other, and aligned with each other along a lateral sensor plane. The method further includes determining a presence or absence of an abnormality in the structure based on the acoustic waves sensed at the piezoelectric sensors. The lateral sensor plane is parallel to the transducer plane. A size of each one of the piezoelectric transducers is greater than a size of each one of the piezoelectric sensors. A distance between the transducer plane and the lateral sensor plane is greater than a distance between adjacent ones of the piezoelectric transducers and greater than a distance between adjacent ones of the piezoelectric sensors. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a top plan view of an aircraft showing a detailed view of an apparatus for detecting an abnormality, according to one or more examples of the present disclosure;

FIG. 2 is a top plan view of an apparatus for detecting an abnormality in a structure, according to one or more examples of the present disclosure;

FIG. 3 is a top plan view of the apparatus of FIG. 2, showing a line-of-site between a piezoelectric transducer and piezoelectric sensors of the apparatus, according to one or more examples of the present disclosure;

FIG. 4 is a top plan view of the apparatus of FIG. 2, showing a net of waves generated by piezoelectric transducers of the apparatus, according to one or more examples of the present disclosure;

FIG. 5 is a schematic block diagram of an electronic controller for controlling actuation of piezoelectric transducers of an apparatus for detecting an abnormality in a structure, and for receiving output from piezoelectric sensors of the apparatus, according to one or more examples of the present disclosure;

FIG. 6 is a side elevation view of an apparatus for detecting an abnormality in a structure, according to one or more examples of the present disclosure;

FIG. 7 is a perspective view of a system including a structure and apparatuses for detecting an abnormality in the structure, according to one or more examples of the present disclosure; and

FIG. 8 is a schematic flow diagram of a method of detecting an abnormality in a structure, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

According to some examples, the present application discloses an apparatus, system, and method that enables detection of an abnormality in a structure in a prompt, efficient, and accurate manner. In certain examples, the apparatus is fixed to and forms part of the structure. Moreover, the apparatus is configured to continuously monitor the structure for abnormalities while the structure is in use. Accordingly, detection of abnormalities in the structure by the apparatus does not require disablement or disassembly of the structure as is commonly associated with conventional methods for detecting abnormalities. Additionally, in various examples, the apparatus provides abnormality detection results to an easily accessible location, such as a location remote or external from the portion of the structure being monitored for abnormalities. Therefore, personnel need not be physically proximate the portion of the structure being monitored, which can eliminate the need to manually access difficult-to-reach locations on a structure as has been associated with conventional methods for detecting abnormalities. Finally, according to certain examples, the apparatus of the present application also utilizes relative sizes and relative spacing of piezoelectric elements to enhance the detectability of abnormalities.

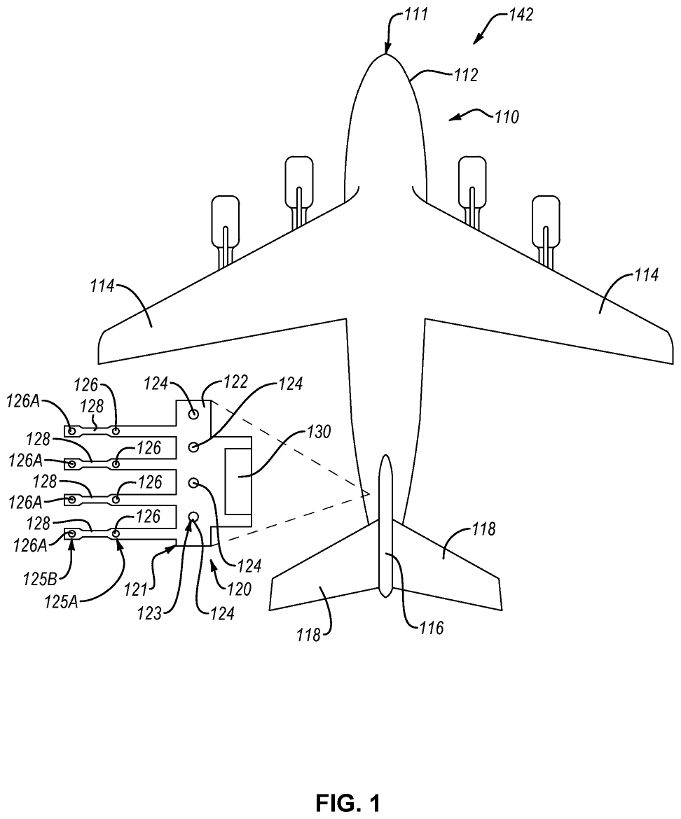

Referring to FIG. 1, according to some examples, a system 142 of the present disclosure includes a structure 110, which, as shown, can be an aircraft 111. The aircraft 111 includes a body 112 or fuselage, a pair of wings 114 coupled to and extending from the body 112, a vertical stabilizer 116 coupled to the body 112, and a pair of horizontal stabilizers 118 coupled to the body 112 and/or the vertical stabilizer 116. The aircraft 111 includes features representative of a commercial passenger or military transport aircraft. However, the aircraft 111 can be any of various other types of commercial or non-commercial aircraft, such as personal aircraft, fighter jets, helicopters, spacecraft, and the like. Moreover, although the structure 110 is an aircraft in FIG. 1, in other examples, the structure 110 can be a structure other than an aircraft, such as a vehicle (e.g., boat, automobile, etc.) or non-mobile complex structure (e.g., building, bridge, machinery, etc.) without departing from the essence of the present disclosure.

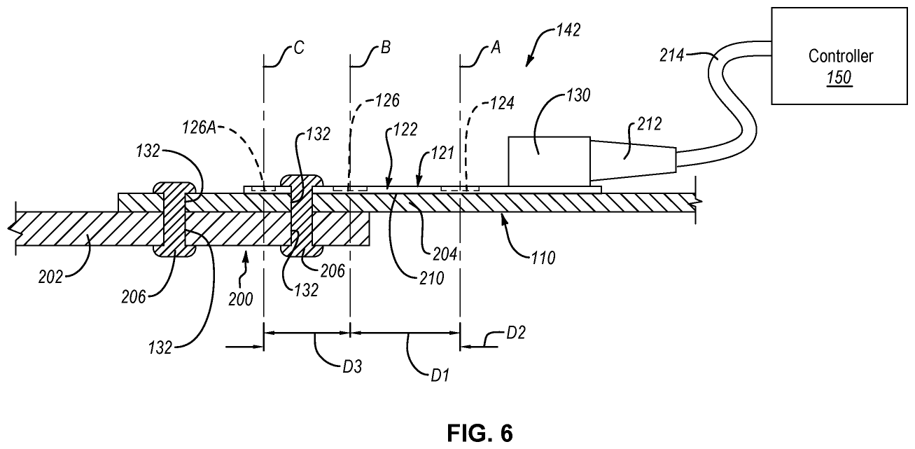

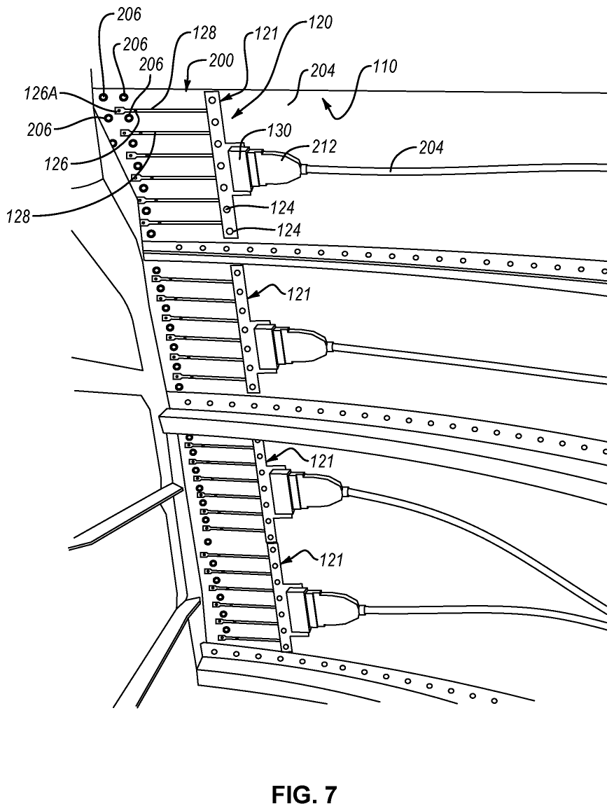

Generally, the body 112, wings 114, vertical stabilizer 116, and horizontal stabilizers 118 of the aircraft 111 each includes an internal frame enveloped by a cover or skin. The cover is coupled to the frame to form an exterior shell of the aircraft. Most commonly, the cover is coupled to the frame using a plurality of fasteners that extend through holes in the cover and engage the internal frame. The aircraft 111 may include additional interior layers or structures with holes formed therein to receive fasteners for coupling other interior components, layers, or structures. For example, referring to FIGS. 6 and 7, the aircraft 111 may include a lap joint 200, which secures together a first component 202 and a second component 204 together via one or more fasteners, such as rivets 206. The lap joint 200 can be any of various types of lap joint. The rivets 206 extend through corresponding holes 132 in the first component 202 and the second component 204. In some examples, as shown, the first component 202 is thicker than the second component 204. When the structure 110 is an aircraft, such as the aircraft 111, the lap joint 200 can be one of many lap joints formed in a pressure bulkhead of the aircraft 111, such as an aft pressure bulkhead. In certain examples, the first component 202 is a circumferential frame of the bulkhead and the second component 204 is a radial web of the bulkhead.

The structure 110, such as the aircraft 111 may include tens of thousands of holes, such as the holes 132, and associated fasteners, such as the rivets 206, in the various portions, components, and sub-structures of the structure 110. Some features of the structure 110, such as the areas adjacent or proximate the holes, can be susceptible to abnormalities, such as cracking, by virtue of experiencing loads and being exposed to corrosive environmental factors. Although the present disclosure includes apparatus, systems, and methods for detecting abnormalities in any of various structures at any of various locations or features of the structures, such as areas around any holes in the structure 110, regardless of susceptibility to abnormalities, in some examples, the present disclosure is configured to target areas in structures that may be more susceptible to abnormalities than other areas. For example, as shown in some of the illustrated examples, only the holes 132 of the aircraft 111 particularly susceptible to abnormalities are monitored for abnormalities using the apparatus, systems, and methods of the present disclosure.

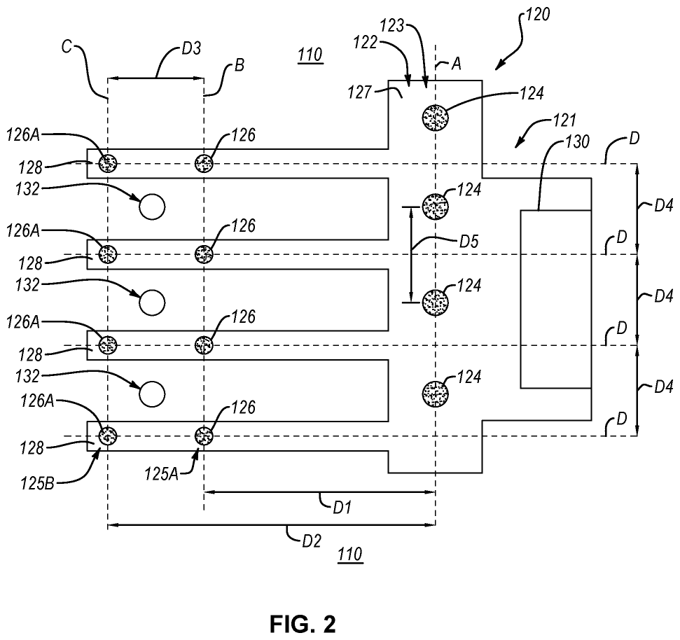

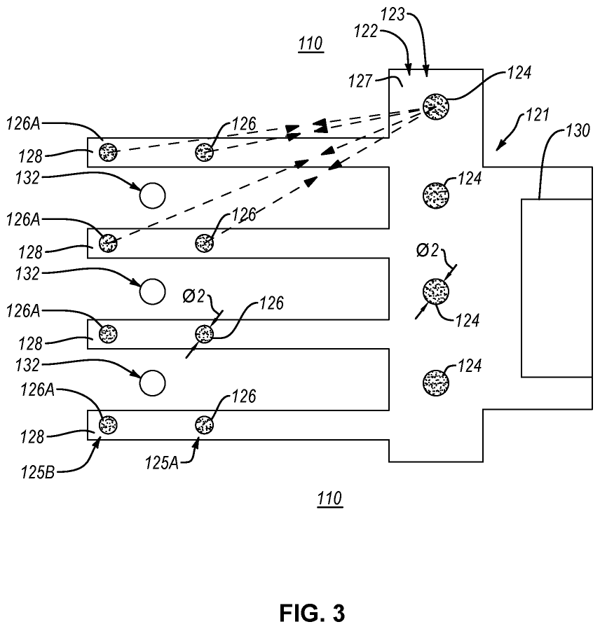

Referring to FIGS. 2 and 3, according to some examples, in addition to the structure 110, the system 142 further includes an apparatus 120 for detecting an abnormality in the structure 110. The apparatus 120 includes a sensing assembly 121 that is coupled to a surface of the structure 110 to be monitored for abnormalities. In other words, the sensing assembly 121 helps detect abnormalities in the material of the structure 110 that defines the surface to which the sensing assembly 121 is coupled. In certain examples, the sensing assembly 121 is attached directly to the surface of the structure 110 using any of various attachment techniques, such as via an adhesive 210 (see, e.g., FIG. 6). Although described in more detail below, in certain examples, the sensing assembly 121 is attached to the structure 110 in close proximity to portions or features of the structure 110 particularly susceptible to abnormalities. Accordingly, as shown in FIG. 3, the sensing assembly 121 is attached to the structure 110 in close proximity to the holes 132 of the structure 110.

The sensing assembly 121 includes a base 122, and piezoelectric transducers 124 and piezoelectric sensors 126 attached to the base 122. Each one of the piezoelectric transducers 124 and piezoelectric sensors 126 includes a piezoelectric element. The base 122 provides a substrate to which the piezoelectric elements are attached and positioned relative to each other. In some examples, the base 122 is made of a sheet of electrically insulating material, such as a polymeric material (e.g., glass epoxy or polyimide). The base 122 can be flexible or rigid. The base 122 can also include electrical traces coupled to (e.g., printed on) the sheet of electrically insulating material. The base 122 can have any of various shapes, depending on the shape of the structure 110 and the configuration of the features of the structure 110. In one example, as shown, the base 122 includes a body 127, or main portion, and elongated fingers 128 extending from the body 127 in the same direction. The elongated fingers 128 are spaced apart from and parallel to each other.

The piezoelectric transducers 124 and the piezoelectric sensors 126 can be attached to the base 122 using any of various techniques, such as bonding, fastening, adhering, and the like. In some examples, the piezoelectric transducers 124 and the piezoelectric sensors 126 are attached to a side of the base 122 that is opposite the side of the base 122 attached to the structure 110. Accordingly, the base 122 is interposed between the piezoelectric transducers 124 and the piezoelectric sensors 126, and the surface of the structure 110.

The piezoelectric element of each one of the piezoelectric transducers 124 and piezoelectric sensors 126 is made of a piezoelectric material. The piezoelectric material is sized and shaped so that the piezoelectric elements of the piezoelectric transducers 124 have a particular size and shape and the piezoelectric elements of the piezoelectric sensors 126 have a particular size and shape. The piezoelectric material can be any of various piezoelectric materials. As defined herein, a piezoelectric material is any solid material that accumulates an electric charge when deformed, and deforms when subject to an electric charge. In other words, not only is a piezoelectric material capable of accumulating an electric charge when subject to a force or load that deforms or otherwise changes the dimensions of the piezoelectric material, but also is capable of changing dimensions to generate a force or load when an electric field is applied to the piezoelectric material. Some examples of piezoelectric materials include some crystalline materials (e.g., lead titanate, quartz, lithium tantalate, and the like), some ceramics (e.g., lead zirconate titanate, potassium niobate, zinc oxide, and the like), some lead-free piezoceramics (e.g., sodium potassium niobate, bismuth ferrite, and the like), some semiconductors (e.g., polar semiconductors, zincblende and wurtzite crystal structures), and some polymers (e.g., polyvinylidene chloride).

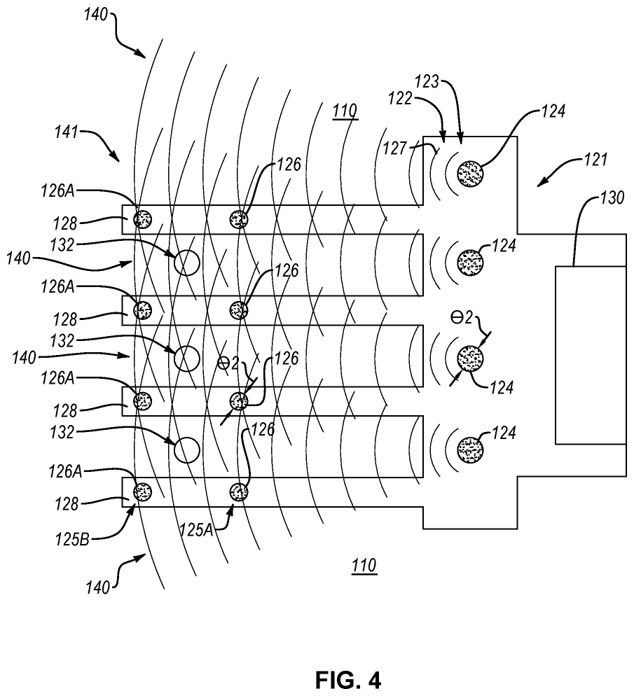

Based on the foregoing, generally speaking, the piezoelectric transducers 124 of the sensing assembly 121 function as piezoelectric transducers because the piezoelectric elements of the piezoelectric transducers 124 are configured only to receive an electric field or current. In contrast, the piezoelectric sensors 126 of the sensing assembly 121 function as piezoelectric sensors because the piezoelectric elements of the piezoelectric sensors 126 are configured only to accumulate an electric charge when deformed by a force or load impacting the piezoelectric elements. The force or load generated by the piezoelectric transducers 124 results in acoustic waves 140 (e.g., lamb waves or elastic waves) that propagate through the structure 110 body 12 and along the surface of the structure 110 to which the sensing assembly 121 is attached (see, e.g., FIG. 4). The acoustic waves 140 are received by the piezoelectric sensors 126, which are deformed by the acoustic waves 140, thus causing the piezoelectric elements of the piezoelectric sensors 126 to accumulate a corresponding electrical charge that can be monitored.

Generally, the power of the accumulated (sensed) electric charge by a piezoelectric sensor 126 is directly proportional to the magnitude of the change in dimension caused by the acoustic wave(s) 140 received at the piezoelectric sensor 126. Thus each one of the piezoelectric sensors 126 piezoelectric sensing elements, operating as an electric accumulator, is able to detect characteristics (e.g., amplitude, frequency, etc.) of received acoustic wave(s) 140. The inverse is also true, which is that the characteristics of the acoustic waves generated by the piezoelectric transducers 124 are directly proportional to the power of the electrical charge applied to the piezoelectric transducers 124. Accordingly, the piezoelectric transducers 124, operating as a wave generators, are able to generate acoustic waves with controlled characteristics. In view of the foregoing, the piezoelectric transducers 124 are configured to generate waves through the structure 110 and the piezoelectric sensors 126 are configured to sense the waves generated by the piezoelectric transducers 124.

The shape, size, and location of the piezoelectric transducers 124 relative to the shape, size, and location of the piezoelectric sensors 126 promote the ability of the apparatus 120 to effectively detect abnormalities in the structure 110. The shape of the acoustic waves 140 generated by the piezoelectric transducers 124 is dependent on the shape of the piezoelectric transducers 124 (i.e., the shape of the piezoelectric elements of the piezoelectric transducers 124). In one example, the piezoelectric elements of the piezoelectric transducers 124 are circular or disc-shaped. Accordingly, the acoustic waves 140 generated by each one of the piezoelectric transducers 124 are circular waves emanating outwardly from the corresponding one of the piezoelectric transducers 124. Referring to FIG. 4, for simplicity, only a quarter of the acoustic waves 140 generated by the piezoelectric transducers 124 is shown. Moreover, in certain examples, such as shown, the piezoelectric elements of the piezoelectric sensors 126 are circular or disc-shaped. The disc-shaped nature of the piezoelectric transducers 124 and the piezoelectric sensors 126 promotes consistent and uniform wave generation, propagation, and detection, respectively.

The piezoelectric transducers 124 are larger than the piezoelectric sensors 126 in some examples. In other words, a size of each one of the piezoelectric transducers 124 is greater than a size of each one of the piezoelectric sensors 126. The larger size of the piezoelectric transducers 124 helps to improve (e.g., maximize) the energy transfer propagation of the acoustic waves 140. In contrast, the smaller size of the piezoelectric sensors 126 helps to increase the detection sensitivity of the piezoelectric sensors 126 to the acoustic waves 140. The relative ratio between the size of the piezoelectric transducers 124 and the piezoelectric sensors 126 is selected to promote the overall efficiency and accuracy of the apparatus 120 for detecting abnormalities. According to one example, the ratio of the size of each one of the piezoelectric transducers 124 to the size of each one of the piezoelectric sensors 126 is between, and inclusive of, 1.5 and 2.5. In yet another example, the ratio of the size of each one of the piezoelectric transducers 124 to the size of each one of the piezoelectric sensors 126 is between, and inclusive of, 1.8 and 2.2 (e.g., about 2.0). According to one example, and for illustrative purposes only, each one of the piezoelectric transducers 124 is disc-shaped and has a diameter of between, 0.20 inches and 0.30 inches (e.g., 0.25 inches), and each one of the piezoelectric sensors 126 is disc-shaped and has a diameter of between, 0.12 inches and 0.13 inches (e.g., 0.125 inches).

The placement of the piezoelectric transducers 124 relative to each other, and relative to the piezoelectric sensors 126, enables acoustic waves 140 from multiple piezoelectric transducers 124 to impact each one of the piezoelectric sensors 126. Receiving multiple acoustic waves 140 from different piezoelectric transducers 124 helps to verify the readings taken by piezoelectric sensors 126 and thus promotes more accurate and reliable results. The multiple acoustic waves 140 from the piezoelectric transducers overlap with each other to form an acoustic wave net 141 (see, e.g., FIG. 4), which encompasses all the piezoelectric sensors 126 in some examples. The piezoelectric sensors 126 receive acoustic waves 140 from multiple piezoelectric transducers 124 because multiple piezoelectric transducers 124 have line-of-sight with each one of the piezoelectric sensors 126, as shown by dashed lines in FIG. 3. In other words, in some examples, no piezoelectric sensor 126 interrupts an acoustic wave 140 from impacting another piezoelectric sensor 126.

According to some examples, line-of-sight between multiple piezoelectric transducers 124 and each one of the piezoelectric sensors 126 is enabled by staggering or offsetting the piezoelectric transducers 124 relative to the piezoelectric sensors 126. Referring to FIG. 2, in certain examples, the piezoelectric transducers 124 are spaced apart from each other and aligned with each other along a transducer plane A. The piezoelectric transducers 124 aligned along the transducer plane A form a set of transducers 123. Similarly, in these examples, the piezoelectric sensors 126 are spaced apart from each other and aligned with each other along a lateral sensor plane B. The piezoelectric sensors 126 aligned along the lateral sensor plane B form a first set of piezoelectric sensors 125A. The lateral sensor plane B is parallel to the transducer plane A and spaced apart from the transducer plane A by a first distance D1. Additionally, a corresponding one of multiple longitudinal sensor planes D passes through each one of the piezoelectric sensors 126. The longitudinal sensor planes D are spaced apart from each other by a fourth distance D4 and are perpendicular to the transducer plane A.

The piezoelectric transducers 124 are staggered, in a direction parallel to the transducer plane A and the lateral sensor plane B, relative to the piezoelectric sensors 126 so that none of the longitudinal sensor planes D pass through the piezoelectric transducers 124. In some examples, as shown, each one of the longitudinal sensor planes D bisects a fifth distance D5 between corresponding adjacent ones of the piezoelectric transducers 124. The fifth distance D5 is equal to the fourth distance D4 in the illustrated examples. Moreover, the fourth distance D4 and the fifth distance D5 is dependent on (e.g., equal to) the spacing or distance between the holes 132 in the structure 110. Accordingly, in certain examples, a longitudinal plane, parallel to the longitudinal sensor planes D and passing through each one of the holes 132, passes through a corresponding one of the piezoelectric transducers 124. In some examples, and by way of example only, the fourth distance D4, the fifth distance D5, and the distance between the holes 132 is between, and inclusive of, 15 mm and 35 mm (e.g., about 24 mm).

The piezoelectric sensors 126 of the first set of piezoelectric sensors 125A are spaced apart from the piezoelectric transducers 124 of the set of transducers 123 in a direction perpendicular to the transducer plane A and the lateral sensor plane B. A distance between the first set of piezoelectric sensors 125A and the set of transducers 123 (i.e., the first distance D1) is selected to ensure the acoustic waves 140 are well-defined (e.g., sufficiently unattenuated) at impact with the piezoelectric sensors 126 and broad enough to impact multiple ones of the piezoelectric sensors 126. The definition and breadth of the acoustic waves 140, and thus the first distance D1, is dependent on the wave attenuation properties of the material of the structure 110, which is based at least partially on the type (e.g., density) and thickness of the material. In one example, a ratio of the first distance D1, between the transducer plane A and the lateral sensor plane B, to a thickness of the structure 110 to which the sensing assembly 121 is attached is between, and inclusive of, 75 and 85, or 78 and 80 (e.g., about 79). In certain illustrative examples, the first distance D1 is between, and inclusive of, 60 mm and 70 mm (e.g., about 64 mm).

Generally, the first distance D1 is greater than the fourth distance D4 between the piezoelectric sensors 126 and the fifth distance D5 between the piezoelectric transducers 124. According to one example, a ratio of the first distance D1 to either the fifth distance D5 or the fourth distance D4 is between, and inclusive of, 2.2 and 3.2. In yet another example, the ratio of the first distance D1 to either the fifth distance D5 or the fourth distance D4 is between, and inclusive of, 2.5 and 2.9 (e.g., about 2.7).

According to additional examples, the sensing assembly 121 includes a second set of piezoelectric sensors 125B attached to the base 122. Second piezoelectric sensors 126A of the second set of piezoelectric sensors 125B are configured the same as the piezoelectric sensors 126. For example, each one of the second piezoelectric sensors 126A includes a piezoelectric element made of a piezoelectric material. In some examples, the second piezoelectric sensors 126A have the same size as the piezoelectric sensors 126. Moreover, the second piezoelectric sensors 126A are spaced apart from each other and aligned with each other along a second lateral sensor plane C. The second piezoelectric sensors 126A aligned along the second lateral sensor plane C form the second set of piezoelectric sensors 125B. The second lateral sensor plane C is parallel to the transducer plane A, and is spaced apart from the transducer plane A by a second distance D2. Also, the second lateral sensor plane C is parallel to the lateral plane B, and is spaced apart from the lateral plane B by a third distance D3. Therefore, the second distance D2 is equal to the sum of the first distance D1 and the third distance D3. Depending on the material of the structure 110, a ratio of the second distance D2 to the thickness of the structure 110 to which the sensing assembly 121 is attached is between, and inclusive of, 100 and 120, or 105 and 115 (e.g., about 110). In certain illustrative examples, the second distance D2 is between, and inclusive of, 80 mm and 100 mm (e.g., about 90 mm).

The second set of piezoelectric sensors 125B provides additional (e.g. redundant) capabilities, relative to the first set of piezoelectric sensors 125A, for detecting abnormalities around features in the structure 110, such as the holes 132. The use of the second set of piezoelectric sensors 125B can promote greater accuracy when detecting abnormalities in the structure 110, help provide alternative networking, offer redundancy (such as when one or more other piezoelectric sensors become inoperable), and/or provide detection of abnormalities on a different side of a feature of the structure 110, such as the holes 132, than the first set of piezoelectric sensors 125A. Although two sets of piezoelectric sensors are shown, in some examples, the sensing assembly 121 can be configured to have more than two sets of piezoelectric sensors.

In some examples, the third distance D3 is less than the first distance D1. A ratio of the first distance D1 to the third distance D3 is between, and inclusive of, 2.0 and 3.0 in some examples. According to one example, the ratio of the first distance D1 to the third distance D3 is about 2.5. Depending on the material of the structure 110, a ratio of the third distance D3 to the thickness of the structure 110 to which the sensing assembly 121 is attached is between, and inclusive of, 25 and 35, or 30 and 32 (e.g., about 31). In certain illustrative examples, the third distance D3 is between, and inclusive of, 20 mm and 30 mm (e.g., about 25 mm). According to these or other examples, the third distance D3 is greater than the fourth distance D4. In some examples, a ratio of the third distance D3 to the fourth distance D4 is greater than 1 and less than, and inclusive of, 1.1 (e.g., about 1.04).

Additionally, a corresponding one of the longitudinal planes D passes through each one of the second piezoelectric sensors 126A. In other words, the second piezoelectric sensors 126A are longitudinally aligned with the piezoelectric sensors 126. Therefore, adjacent ones of the second piezoelectric sensors 126A are separated by a distance equal to the fourth distance D4 between adjacent ones of the piezoelectric sensors 126.

According to some examples, the sensing assembly 121 is located on the structure 110, relative to the holes 132, such that a longitudinal plane, passing through each one of the holes 132 and perpendicular to the plane B and the plane C, bisects the fourth distance D4 between corresponding adjacent ones of the piezoelectric sensors 126 and between corresponding adjacent ones of the second piezoelectric sensors 126A. Additionally, in the same examples, the sensing assembly 121 is located on the structure 110, relative to the holes 132, such that a lateral or hole plane, passing through the holes 132 and parallel to the plane B and the plane C, bisects the third distance D3 between the plane B and the plane C.

In certain examples, where the base 122 of the sensing assembly 121 has the body 127 and the elongated fingers 128, the piezoelectric transducers 124 are attached directly to the body 127 and each one of the piezoelectric sensors 126 is attached directly to a corresponding one of the elongated fingers 128. Similarly, according to certain examples, each one of the second piezoelectric sensors 126A is also attached directly to a corresponding one of the elongated fingers 128. Although not shown, each one of the piezoelectric transducers 124, the piezoelectric sensors 126, and the second piezoelectric sensors 126A (when used) is electrically coupled with a corresponding one of the multiple traces of the base 122. When attached to the structure 110 proximate the holes 132, each one of the holes 132 is between corresponding adjacent ones of the elongated fingers 128. Although the base 122 of the sensing assembly 121 shown in FIGS. 1-4 includes four elongated fingers 128, in other examples, the base 122 can have less than or more than our elongated fingers 128. For example, each one of the sensing assemblies 121 shown in FIG. 7 has either six or seven elongated fingers 128.

The sensing assembly 121 further includes a data communications module 130 coupled to the base 122, such as attached directly to the body 127 of the base 122. The data communications module 130 is electrically coupled with the traces of the base 122 to send electrical power to the piezoelectric transducers 124, and to receive electrical power from the piezoelectric sensors 126 and the second piezoelectric sensors 126A (when used).

Referring to FIG. 7, according to some examples, the system 142 includes a plurality of sensing assemblies 121 attached to structure 110. The sensing assemblies 121 can be aligned (e.g., circumferentially aligned) relative to each other such that the lateral planes of one sensing assembly 121 are co-planar with the corresponding lateral planes of all the sensing assemblies 121. In this manner, multiple sensing assemblies 121 can be operated cooperatively to detect abnormalities in a larger portion of the structure 110, such as where other components of the structure 110 may restrict the size of each sensing assembly 121. As shown, the sensing assemblies 121 are shown attached to the second component 204 of the lap joint 200, where a longitudinal beam is interposed between each one of the sensing assemblies 121. The multiple sensing assemblies 121 can be coupled to a single electronic controller 150 or multiple, respective electronic controllers 150.

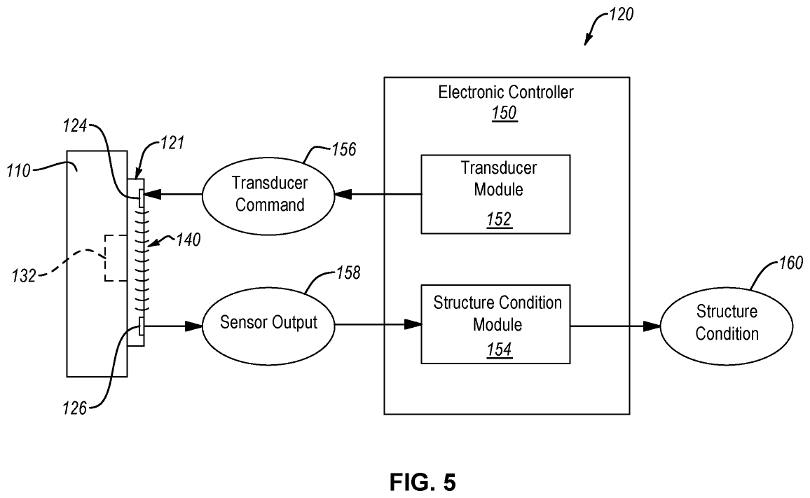

Referring to FIG. 5, in some examples, the apparatus 120 further includes an electronic controller 150 operably coupleable with the data communications module 130 of the sensing assembly 121 to provide data and/or power to the data communications module 130. In some examples, the electronic controller 150 is operably coupleable with the data communications module 130 via a wired connection, such as via an electrical connector 212 and a cable 214. However, in other examples, the electronic controller 150 is operably coupleable with the data communications module 130 via a wireless connection, such as via a wireless transceiver of the data communications module 130.

The electronic controller 150 includes a transducer module 152 and a structure condition module 154 in some examples. The transducer module 152 is configured to generate a transducer command 156, which is communicated to the data communications module 130. The data communications module 130 then sends power signals to the piezoelectric transducers 124 that activate or excite the piezoelectric transducers 124 resulting in the acoustic waves 140 being generated and passing through the structure 110. The intensity and frequency of the acoustic waves 140 corresponds with the intensity and frequency commanded by the transducer command 156.

The structure condition module 154 is configured to determine whether an abnormality is present in the structure 110 at least partially in response to sensor output 158 from the piezoelectric sensors 126. When the piezoelectric sensors 126 (and second piezoelectric sensors 126A when present) vibrate when impacted by the acoustic waves 140, the piezoelectric elements convert the vibrations into a voltage, which is transmitted to the structure condition module 154 as the sensor output 158. In one example, the structure condition module 154 compares the voltage characteristics of the sensor output 158 with expected or baseline voltage characteristics to detect the presence of an abnormality in the structure 110. The expected voltage characteristics represent the voltage characteristics expected to be generated by the piezoelectric elements in response to hypothetical acoustic waves with specific characteristics passing through a structure without abnormalities. Accordingly, variations in the voltage characteristics of the sensor output 158 compared to the expected voltage characteristics indicate one or more abnormalities or damage (e.g., cracking) in the structure 110. For a proper comparison, the transducer command 156 generated by the transducer module 152 commands the piezoelectric transducers 124 to generate acoustic waves in the structure 110 with characteristics matching the hypothetical acoustic waves. The structure condition module 154 generates a structure condition 160 in response to the comparison and whether one or more abnormalities are present. The structure condition 160 can include any of various indicators of the condition of the structure 110, such as the presence or absence of an abnormality, a type, shape, and/or size of a detected abnormality, and the like.

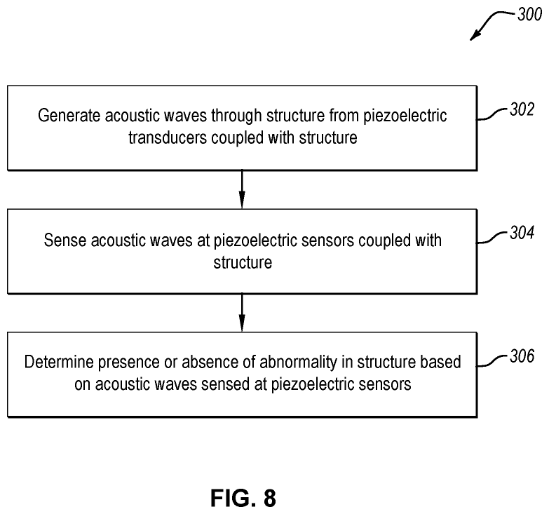

Referring to FIG. 8, and according to one example, a method 300 of detecting one or more abnormalities in the structure 110 includes (block 302) generating the acoustic waves 140 through the structure 110 from the piezoelectric transducers 124 of the sensing assembly 121. The method 300 also includes (block 304) sensing the acoustic waves 140 at the piezoelectric sensors 126 (and/or the second piezoelectric sensors 126A) of the sensing assembly 121 coupled with the structure 110. In some examples, each one of the piezoelectric sensors 126 senses acoustic waves 140 generated by multiple ones of the piezoelectric transducers 124. The method 300 further includes (block 306) determining a presence or absence of an abnormality in the structure 110 based on the acoustic waves 140 sensed at the piezoelectric sensors 126.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The term “about” or “substantially” or “approximately” in some examples, is defined to mean within +/−5% of a given value, however in additional examples any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

The schematic flow chart diagram included herein is generally set forth as logical flow chart diagram. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Blocks represented by dashed lines indicate alternative operations and/or portions thereof. Dashed lines, if any, connecting the various blocks represent alternative dependencies of the operations or portions thereof. It will be understood that not all dependencies among the various disclosed operations are necessarily represented.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The described features, structures, or characteristics of the examples may be combined in any suitable manner. In the above description, numerous specific details are provided, such as examples of programming, software modules, user selections, network transactions, database queries, database structures, hardware modules, hardware circuits, hardware chips, etc., to provide a thorough understanding of examples. One skilled in the relevant art will recognize, however, that examples may be practiced without one or more of the specific details, or with other methods, components, materials, and so forth. In other instances, well-known structures, materials, or operations are not shown or described in detail to avoid obscuring aspects of an example.

Aspects of the examples are described above with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods and program products according to various examples. In this regard, each block in the schematic flowchart diagrams and/or schematic block diagrams may represent a module, segment, or portion of code, which comprises one or more executable instructions of the code for implementing the specified logical function(s).

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus for detecting an abnormality in a structure, the apparatus comprising:
a base configured to be attached to the structure;
piezoelectric transducers configured to generate waves through the structure, coupled to the base, spaced apart from each other, and aligned with each other along a transducer plane; and
piezoelectric sensors configured to sense the waves generated by the piezoelectric transducers, coupled to the base, spaced apart from each other, and aligned with each other along a lateral sensor plane, wherein a distance between adjacent ones of the piezoelectric sensors is the same;
wherein:
the lateral sensor plane is parallel to the transducer plane;
a size of each one of the piezoelectric transducers is greater than a size of each one of the piezoelectric sensors; and
a distance between the transducer plane and the lateral sensor plane is greater than a distance between adjacent ones of the piezoelectric transducers and greater than a distance between adjacent ones of the piezoelectric sensors.

2. The apparatus according to claim 1, wherein a ratio of the size of each one of the piezoelectric transducers to the size of each one of the piezoelectric sensors is between, and inclusive of, 1.5 and 2.5.

3. The apparatus according to claim 2, wherein the ratio of the size of each one of the piezoelectric transducers to the size of each one of the piezoelectric sensors is between, and inclusive of, 1.8 and 2.2.

4. The apparatus according to claim 1, wherein a ratio of the distance between the transducer plane and the lateral sensor plane to either the distance between adjacent ones of the piezoelectric transducers or the distance between adjacent ones of the piezoelectric sensors is between, and inclusive of, 2.2 and 3.2.

5. The apparatus according to claim 4, wherein the ratio of the distance between the transducer plane and the lateral sensor plane to either the distance between adjacent ones of the piezoelectric transducers or the distance between adjacent ones of the piezoelectric sensors is between, and inclusive of, 2.5 and 2.9.

6. The apparatus according to claim 1, wherein:
the distance between adjacent ones of the piezoelectric transducers is the same; and
the distance between adjacent ones of the piezoelectric sensors is the same.

7. The apparatus according to claim 1, wherein each one of the piezoelectric transducers and the piezoelectric sensors is disc-shaped.

8. The apparatus according to claim 1, wherein the piezoelectric transducers are staggered, in a direction parallel to the transducer plane and the lateral sensor plane, relative to the piezoelectric sensors such that longitudinal sensor planes, each passing through a corresponding one of the piezoelectric sensors and each being perpendicular to the transducer plane and the lateral sensor plane, do not pass through any one of the piezoelectric transducers.

9. The apparatus according to claim 8, wherein each one of the longitudinal sensor planes passing between adjacent ones of the piezoelectric transducers bisects the distance between the adjacent ones of the piezoelectric transducers.

10. The apparatus according to claim 1, further comprising second piezoelectric sensors coupled to the base, spaced-apart from each other, each having a size less than the size of each one of the piezoelectric transducers, and aligned with each other along a second lateral sensor plane, wherein:
adjacent ones of the second piezoelectric sensors are separated by a distance equal to the distance between adjacent ones of the piezoelectric sensors;
the second lateral sensor plane is parallel to and spaced apart from the lateral sensor plane; and
each one of the second piezoelectric sensors is aligned with a corresponding one of the piezoelectric sensors along a corresponding one of longitudinal sensor planes that are perpendicular to the transducer plane and the lateral sensor plane.

11. The apparatus according to claim 10, wherein a distance between the lateral sensor plane and the second lateral sensor plane is greater than the distance between adjacent ones of the piezoelectric sensors and less than the distance between the transducer plane and the lateral sensor plane.

12. The apparatus according to claim 11, wherein the size of each one of the second piezoelectric sensors is the same as the size of each one of the piezoelectric sensors.

13. The apparatus according to claim 1, further comprising a data communications module coupled to the base and electrically coupleable, in electrical-power providing communication, to each one of the piezoelectric transducers, and electrically coupleable, in electrical-power receiving communication, to each one of the piezoelectric sensors.

14. The apparatus according to claim 13, further comprising an electronic controller communicable in data providing and data receiving communication with the data communications module, wherein the electronic controller comprises:
a transducer module configured to generate a transducer command, wherein the piezoelectric transducers generate waves through the structure in response to receiving the transducer command; and
a structure condition module configured to determine whether an abnormality is present in the structure at least partially in response to sensor output from the piezoelectric sensors.

15. The apparatus according to claim 1, wherein the base comprises:
a body; and
elongated fingers extending from the body and spaced apart relative to each other;
wherein:
the piezoelectric transducers are coupled directly to the body; and
each one of the piezoelectric sensors is coupled directly to a corresponding one of the elongated fingers.

16. The apparatus according to claim 1, wherein each one of the piezoelectric transducers has line-of-sight with each one of the piezoelectric sensors.

17. A system comprising:
a structure; and
an apparatus for detecting an abnormality in the structure, the apparatus being attached to the structure and comprising:
a base;
piezoelectric transducers configured to generate waves through the structure, coupled to the base, spaced apart from each other, and aligned with each other along a transducer plane, wherein a distance between adjacent ones of the piezoelectric transducers is the same; and
piezoelectric sensors configured to sense the waves generated by the piezoelectric transducers, coupled to the base, spaced apart from each other, and aligned with each other along a lateral sensor plane, wherein a distance between adjacent ones of the piezoelectric sensors is the same;
wherein:
the lateral sensor plane is parallel to the transducer plane;
a size of each one of the piezoelectric transducers is greater than a size of each one of the piezoelectric sensors;
a distance between the transducer plane and the lateral sensor plane is greater than the distance between adjacent ones of the piezoelectric transducers and greater than the distance between adjacent ones of the piezoelectric sensors; and
a ratio of the distance, between the transducer plane and the lateral sensor plane, to a thickness of the structure is between, and inclusive of, 75 and 85.

18. The system according to claim 17, wherein the ratio of the distance, between the transducer plane and the lateral sensor plane, to a thickness of the structure is between, and inclusive of, 78 and 80.

19. The system according to claim 17, wherein:
the structure comprises holes spaced apart from each other and aligned with each other along a hole plane that is parallel to the transducer plane and the lateral sensor plane;
the base comprises:
a body; and
elongated fingers extending from the body and spaced apart relative to each other;
the piezoelectric transducers are coupled directly to the body;
each one of the piezoelectric sensors is coupled directly to a corresponding one of the elongated fingers; and
each one of the holes is between corresponding adjacent ones of the elongated fingers.

20. A method of detecting an abnormality in a structure, the method comprising:
generating acoustic waves through the structure from piezoelectric transducers coupled with the structure, spaced apart from each other, and aligned with each other along a transducer plane;
sensing the acoustic waves at piezoelectric sensors coupled with the structure, spaced apart from each other, and aligned with each other along a lateral sensor plane; and
determining a presence or absence of an abnormality in the structure based on the acoustic waves sensed at the piezoelectric sensors;
wherein:
the lateral sensor plane is parallel to the transducer plane;
a size of each one of the piezoelectric transducers is greater than a size of each one of the piezoelectric sensors; and
a distance between the transducer plane and the lateral sensor plane is greater than a distance between adjacent ones of the piezoelectric transducers and greater than a distance between adjacent ones of the piezoelectric sensors.
